(19) United States
(12) Patent Application Publication
(10) Pub. No.: US 2025/0035187 A1
(43) Pub. Date: Jan. 30, 2025

(54) TOOTHED BELTS INCLUDING TEETH WITH ASYMMETRIC PROFILE

(71) Applicant: Gates Corporation, Denver, CO (US)

(72) Inventors: Jordyn HARBERTS, Englewood, CO (US); Elizabeth AMICI, Englewood, CO (US)

(73) Assignee: Gates Corporation, Denver, CO (US)

(21) Appl. No.: 18/912,230

(22) Filed: Oct. 10, 2024

Related U.S. Application Data
(63) Continuation of application No. 18/448,052, filed on Aug. 10, 2023, now Pat. No. 12,140,202.
(60) Provisional application No. 63/396,599, filed on Aug. 10, 2022.

(51) Int. Cl. F16G 1/28; F16H 7/02

(52) U.S. Cl. CPC F16G 1/28; F16H 7/02

(57) ABSTRACT

Embodiments of a toothed belt including asymmetric tooth profiles are described. The teeth of the toothed belt include a vertical segment on the leading side of the tooth that allows the teeth to carry increased loads. This in turn helps prevent tooth jump. A conjugate sprocket configured to smoothly enter and exit the toothed belt is also described, and the toothed belt and conjugate sprocket may form part of a belt drive system.

### BACKGROUND

When a shock load is applied to a drive system including a toothed belt and a sprocket, the teeth of the belt can jump over the sprocket land into the next groove in the direction the belt is turning. This occurrence is often referenced as tooth jump. This can cause issues in the operation of the drive system, as well as in delamination of the belt, tooth wear, material fatigue, and ultimately belt failure.

Another issue that may arise with drive systems including a toothed belt and a sprocket is poor meshing between the belt and sprocket profiles. Poor meshing such as this can create noise. Because noise reduction is one of the main advantages of belt drives over chain drives, the creation of noise from poor meshing in a belt drive system is highly undesirable.

A number of design strategies for toothed belt and pulley profiles have been proposed in the prior art. Representative of the art is U.S. Pub No 2009/0156341 which discloses a belt and sprocket system comprising a tensile cord disposed within a belt body, a tooth projecting from the belt body, the tooth having a profile having at least two unequal radii connected in series and disposed between a tooth tip and a tooth root, a sprocket having a groove for receiving the tooth, the groove profile comprising at least one substantially linear portion disposed between the at least two unequal radii, a tooth tip engaging a predetermined portion of the sprocket groove such that the tensile cord is supported in a manner to cause the tensile cord to have a substantially arcuate form between the tooth roots. However, these designs typically focus on the tooth tip engagement with a sprocket, rather than engagement of the leading side of the tooth against which force is exerted.

Accordingly, a need exists for improvements in belt drive systems, with specific focus on solving issues relating to tooth jump and noise creation.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a toothed belt is described, the toothed belt generally including a main belt body portion, and a plurality of teeth spaced apart about the whole inner circumference of the belt and extending in a radially inward direction from the main belt body portion. Each tooth of the toothed belt generally includes a height extending from a land to an apex, and the cross-sectional profile of each tooth includes a vertical segment at a leading side of the tooth, the vertical segment being oriented substantially perpendicular to the main belt body portion when the toothed belt is in a rack state. The length of the vertical segment of each tooth is less than the height of the tooth.

In some embodiments, a belt drive system is described, the belt drive system generally including a toothed belt as described in the preceding paragraph, and a conjugate sprocket configured for engaging with and rotating the toothed belt. The conjugate sprocket includes a plurality of teeth, wherein the shape of each tooth of the conjugate sprocket and the spacing between adjacent teeth in the conjugate sprocket are configured to smoothly mesh with the teeth of the toothed belt.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a cross-sectional view showing the profile of a tooth of a toothed belt configured in accordance with various embodiments described herein.

FIG. 1A is a cross-sectional view showing the profile of a tooth of a tooth of a toothed belt configured in accordance with various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

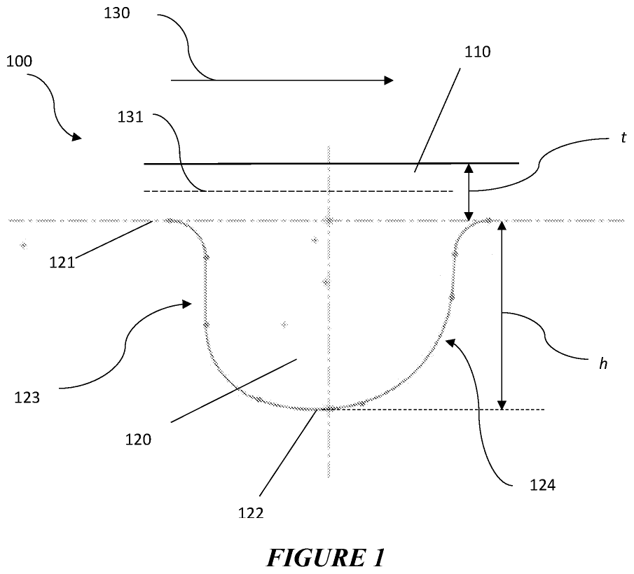

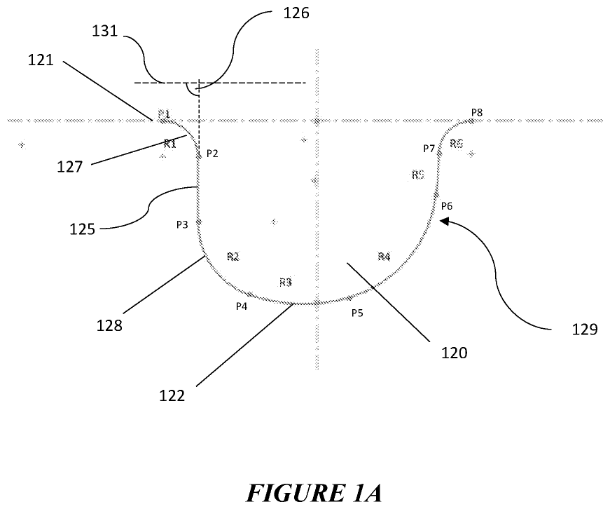

With respect to FIG. 1, a toothed belt 100 configured in accordance with various embodiments described herein is shown. The toothed belt 100 generally includes a main belt body portion 110 and a plurality of teeth 120 extending from the main belt body portion 110 in a radially inward direction. The main body portion may have a thickness t, which is generally not limited and may vary based on the specific application of the toothed belt 100. In FIG. 1, the toothed belt 100 is shown in a rack state, meaning the belt 100 is laid flat, rather than having any degree of curvature. In this rack state, the belt 100 includes a longitudinal axis 131.

While FIG. 1 shows a single tooth 120, it should be appreciated that teeth 120 are arranged around the entire inner circumference portion of the main body portion 110 and are spaced apart from each other at even intervals. It should further be appreciated that each tooth 120 included in toothed belt 100 is generally identical in shape and size (the specifics of which are discussed in greater detail below).

As further shown in FIG. 1, each tooth 120 has a height h extending from the land 121 adjacent the tooth 120 to the apex 122 of the tooth. Each tooth 120 further includes a leading side 123 and a trailing side 124. The leading side 123 is the side of the tooth 120 against which force is exerted, typically via a tooth of a conjugate sprocket pushing against the leading side 123 in order to move the toothed belt 120 in a direction indicated by arrow 130. As discussed in greater detail below, the trailing side 124 of each tooth 120 is generally shaped in order to provide for smooth meshing between the sprocket and the toothed belt 100 (i.e., smooth entry and exit of the sprocket teeth into the spaces between teeth 120 of toothed belt 100).

With reference to FIG. 1A, the cross-sectional profile of tooth 120 is shown. The cross-sectional profile of tooth 120 includes a vertical segment 125 between the land 121 and the apex 122 of the tooth 120 on the leading side 123 of tooth 120. This vertical segment 125 is provided in order to increase the load that can be carried by the tooth 120. The vertical segment 125 is perpendicular to the direction of the force applied to the tooth by a tooth of a conjugate sprocket. This allows for greater forces to be applied to the belt without the belt tooth jumping over the teeth of the sprocket.

Vertical segment 125 is located between points P2 and P3 shown in FIG. 1A, with point P2 marking the radial outer end of vertical segment 125 and P3 marking the radial inner end of vertical segment 125. Vertical segment 125 when extended to intersect with the longitudinal axis 131 of the main body portion 110 when the belt 100 is in a rack (i.e., flat) state forms an angle 126 with the longitudinal axis 131. To provide the desired vertical orientation for the vertical segment 125, angle 126 is generally 90°. In other words, the vertical segment is generally oriented perpendicular to the longitudinal axis 131 of the main belt body portion 110. In some embodiments, the angle 126 need not be exactly 90°. For example, in some embodiments, angle 126 is within the range of from 86° to 110°, in which case the vertical segment 125 still provides the desired improvement in the amount of force that can be applied to the tooth 120 without resulting in tooth jump.

As shown in FIG. 1A, the length of vertical segment 125 is generally less than the height h of the tooth 120. Provided the length of vertical segment 125 is less than the height h of the tooth 120, the length of the vertical segment 125 is generally not limited. In some embodiments, the length of vertical segment 125 is from 10% to 90% of the height h of the tooth 120. In some embodiments, the length of the vertical segment 125 is from 30% to 60% of the height h of the tooth.

Providing a vertical segment 125 that has a length that is less than the height h of the tooth 120 permits the leading side 123 of tooth 120 to have a first curved portion 127 between land 121 and the radial outer end P2 of vertical segment 125 and a second curved portion 128 between inner radial end P3 of vertical segment 125 and the apex 122 of tooth 120. First curved portion 127 may generally be between points P1 and P2 shown in FIG. 1A, while second curved portion 128 may generally be from point P3 to point intermediate points P4 or P5. These curved portions provide gradual transitions near the junction of the tooth and the main belt body portion and near the apex of the tooth. The first curved portion 127 and the second curved portion 128 may make manufacture of the tooth profile easier, and may also contribute to better meshing between the toothed belt and the conjugate sprocket.

At the trailing side of tooth 120, a third curved portion 129 may be provided, the third curved portion generally extending from the apex of tooth 120 down to the junction of the trailing side of the tooth 120 and the main belt body portion. The third curved portion 129 may extend from a point intermediate points P4 and P5 down to point P8. The third curved portion 129 may therefore include convex and concave curved portions. In some embodiments, the third curved portion 129 is free of or substantially free of a vertical segment such that the trailing side of tooth 120 does not include a vertically oriented segment. By providing a trailing side of the tooth 120 in this manner, the tooth profile disclosed herein allows for smooth entry and exit from the conjugate sprocket, which improves meshing and reduces noise.

Tables 1 and 2 below provide exemplary (though non-limiting) data for the location of points P1 through P8 and the radius of curvature R1 through R6 for the segments between adjacent points. This data is exemplary only, and the values for both the points P1 through P8 and R1 through R6 may be readily adjusted. The only constant for the given data is that there is no radius of curvature between points P2 and P3 since the segment between points P2 and P3 is the vertical segment 125. The data shown in Table 2 indicates that the X location between points P2 and P3 does not change, thus indicating a perpendicular orientation for the vertical segment 125. However, in embodiments where the vertical segment is oriented at an angle between 86° and 110°, the X location between points P2 and P3 may change slightly. Regardless, there is still no radius of curvature for this segment, as the vertical segment 125 is a straight segment.

TABLE 1

Center Points

| | Radius | X | Y |
|---|---|---|---|
| R1 | 0.98409 | −4.25987 | −0.98409 |
| R2 | 2.10558 | −1.17020 | −2.79115 |
| R3 | 4.49790 | −0.36940 | −0.53684 |
| R4 | 3.35269 | −0.05546 | −1.63818 |
| R5 | 11.49028 | −8.13396 | −0.65926 |
| R6 | 0.90600 | 4.25987 | −0.90600 |

TABLE 2
Segment Intersections

| | X | Y |
|---|---|---|
| P1 | −4.25987 | 0 |
| P2 | −3.27578 | −0.98409 |
| P3 | −3.27578 | −2.79115 |
| P4 | −1.87502 | −4.77526 |
| P5 | 0.86362 | −4.86243 |
| P6 | 3.27288 | −2.04149 |
| P7 | 3.35405 | −0.88797 |
| P8 | 4.25987 | 0 |

As noted previously, the embodiments of the toothed belt described herein may further employ a conjugate sprocket for engaging with and rotating the toothed belt. The combination of the toothed belt as described herein and the conjugate sprocket can form a belt drive system. The conjugate sprocket generally includes teeth and grooves sized and shaped so as to provide a dynamic fit between the toothed belt and the conjugate sprocket that allows the sprocket teeth to smoothly enter and exit the toothed belt. More specifically, the shape of the sprocket teeth, the shape of the grooves between sprocket teeth, and the spacing between sprocket teeth are all designed to accommodate at least the vertical segment portion of the leading edge of the teeth of the toothed belt. This vertical segment may require the sprocket design to have a “scooped out” profile that accounts for the vertical segment on the teeth of the toothed belt. By providing a sprocket design specifically configured for engaging with the specific profile of the toothed belt (i.e., the vertical segment of the leading edge of the teeth of the toothed belt), the conjugate sprocket provides for smooth meshing with the teeth of the toothed belt, which may help both with belt drive system performance and noise reduction.

Any suitable method for making the toothed belts described herein can be used. In some embodiments, a toothed belt is made using a molding process, including a slab build molding process. When a molding process is used, molds are created to form teeth having the asymmetrical profile with vertical segment described herein.

The material of the toothed belt 100 described herein is generally not limited, and any suitable material for the different components of the toothed belt can be used. Typically, the base material used for the main belt body portion 110 and the teeth 120 is a polymer material, such as a natural or synthetic rubber material, though other suitable materials may also be used (e.g., polyurethanes). Various filler materials may also be included within the material of the main belt body portion and/or teeth to add further structural stability to the belt, while in other embodiments, the belt may be free or substantially free of fillers. The toothed belt 100 shown in FIGS. 1 and 1A may also include additional features not shown in the FIGURES. For example, a cover layer may be provided on the exterior surface of the teeth 120, a backing layer may be provided on the radially outer surface of the main belt body portion 110, and/or a plurality of cords may be embedded within the main belt body portion 110.

Various advantages are provided by way of the toothed belts as described herein. Some of these advantages have been previously discussed, such as the ability to carry a heavier load and noise reduction. Additionally, the toothed belts as described herein allow for greater hub loads compared existing profiles. With improved performance, it is possible to reduce belt widths for equivalent specifications or increase the range of applications compared to released tooth profiles. Furthermore, customers benefit from the design described herein with improved performance with respect to decreased noise and less tooth jump. High end drive system performance can be brought to mid-market applications at reduced cost.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1.-9. (canceled)

10. A belt drive system, comprising:
a toothed belt, comprising:
a main belt body portion; and
a plurality of teeth evenly spaced apart the entirety of an inner circumference of the belt, each tooth extending in a radially inward direction from the main belt body portion, and each tooth having a height extending from a land to an apex, wherein the cross-sectional profile of each tooth comprises:
at a leading side of the tooth, a vertical segment oriented substantially perpendicular to a longitudinal axis of the main belt body portion when the toothed belt is in a rack state, the length of the vertical segment being less than the height of the tooth; and
a conjugate sprocket configured for engaging with and rotating the toothed belt, the conjugate sprocket comprising a plurality of teeth, wherein:
the shape of each tooth of the conjugate sprocket and the spacing between adjacent teeth in the conjugate sprocket are configured to smoothly mesh with the teeth of the toothed belt.

11. The belt drive system of claim 10, wherein the shape of each tooth of the conjugate sprocket and the spacing between adjacent teeth in the conjugate sprocket are specifically adapted such that the conjugate sprocket accommodates the vertical segment of the teeth of the toothed belt.

12. The belt drive system of claim 11, wherein the angle of the sprocket vertical segment with respect to the longitudinal axis of the main belt body portion when the belt is in a rack state is in the range of from 860 to 110°.

13. The belt drive system of claim 11, wherein the angle of the sprocket vertical segment with respect to the longitudinal axis of the main belt body portion when the belt is in a rack state is 90°.

14. The belt drive system of claim 11, wherein the length of the sprocket vertical segment is from 10 to 90% of the sprocket tooth height.

15. The belt drive system of claim 11, wherein the length of the sprocket vertical segment is from 30 to 60% of the sprocket tooth height.

16. The belt drive system of claim 10, wherein the cross-sectional profile of each sprocket tooth further comprises:
at the leading side of the tooth, a first curved portion extending from the land to a radial outer end of the vertical segment; and
at the leading side of the tooth, a second curved portion extending from a radial inner end of the vertical segment to the apex of the tooth.

17. The belt drive system of claim 10, wherein the cross-sectional profile of each sprocket tooth further comprises:
at a trailing side of the tooth, a third curved portion extending from the apex of the tooth to the land, the third curved portion being substantially free of a vertical segment.

18. The belt drive system of claim 17, wherein the third curved portion is configured to provide for smooth meshing between the toothed belt and a corresponding sprocket.

19. The belt drive system of claim 17, wherein the third portion is configured to provide for reduced noise during meshing between the toothed belt and a corresponding sprocket.
